(19) United States
(12) Patent Application Publication
(10) Pub. No.: US 2002/0058113 A1
(43) Pub. Date: May 16, 2002

(54) Filler for automobile insignia

(76) Inventor: Derrick J. Dimone, Oakland Park, FL (US)

Correspondence Address: LERNER AND GREENBERG, P.A., POST OFFICE BOX 2480, HOLLYWOOD, FL, 33022-2480, US

(21) Appl. No.: 10/036,178

(22) Filed: Nov. 9, 2001

Related U.S. Application Data
(60) Provisional application No. 60/247,663, filed on Nov. 9, 2000.

(51) Int. Cl. B32B 3/14

(52) U.S. Cl. 428/31; 428/67

(57) ABSTRACT

A filler decorates an automobile insignia that defines at least one space. The filler includes an insert filling the space. The insert includes a colored layer. The colored layer can be a polyester or vinyl film. A lens overlays and connects to the outside of the colored layer. The lens has a relatively high refractive index. A magnet for attracting an automobile underlies and connects to the inside of the colored layer. The magnet is rubberized. An adhesive underlying the magnet can attach to an automobile. The adhesive can be double-sided tape.

### CROSS REFERENCES TO RELATED APPLICATIONS

This application claims the benefit of U.S. Provisional Application No. 60/247,663, filed on Nov. 9, 2000.

### BACKGROUND OF THE INVENTION

1. Field of the Invention

The invention relates to color inserts that decorate automobile insignia. In particular, the invention relates to resin containing inserts that decorate an automobile insignia by attaching to the automobile.

2. DESCRIPTION OF THE RELATED ART

Rockwood (U.S. Pat. No. 4,556,588) discloses a Decorative Emblem Useful in Customizing an Automobile and Other Surfaces. The Emblem has a backing with a rim. A foil emblem is placed on the backing. A thermoset plastic cap is formed within the rim and acts as a lens over the foil emblem. A pressure sensitive adhesive holds the rear of the backing onto a car. Rockwood encapsulates an emblem and does not retrofit and augment an existing emblem.

Kaumeyer (U.S. Pat. No. 5,480,688) discloses a Shaped Flexible Decorative Article and Method for Making Same. The invention involves casting a flexible substrate to a shaped (non-planar) surface. A polyurethane lens is added to the substrate. The polyurethane lens enhances the view of the underlying layer. An adhesive layer is added to the substrate for adhesion to a car panel. The decorative article is intended to cover the entire emblem being enhanced. In addition, the product must be cast during construction on a non-planar surface.

Lytle (U.S. Pat. No. 6,052,933) discloses a Picture Framing System. The system includes two congruent surfaces. The front surface is transparent and the rear surface can be transparent or opaque. The surfaces are attached about their periphery to form an envelope. A picture can be slid into the envelope. A rubberized magnetic sheet is attached with adhesive to the back surface. The magnetic sheet allows the system to be attached to a metallic surface. The system does not involve an automobile insignia. The system does not discuss coloring the transparent surfaces.

Ogikubo (U.S. Pat. No. 5,994,990) discloses a Magnet Sheet for Display. The magnetic sheet is very thin—between 0.15 mm to 0.1 mm thick. The magnetic sheet can be printed on by a laser printer. The magnetic sheet is made by extruding a resin sheet containing ferromagnetic particles and applying a magnetic field to arrange the poles of the particles. Ogikubo does not show a thick transparent layer that reflects and magnifies an underlying colored layer.

Reid et al. (U.S. Pat. No. 5,740,557) disclose a Magnetic Image-Display System for Apparel. The system includes a metal base plate that attaches to a piece of clothing. The magnetic material is like a kitchen refrigerator magnet. The system does not involve automobile insignia. No transparent resin is added to the magnet's surface to provide coloring or prismatic effects.

Noone et al. (U.S. Pat. No. 5,549,940) disclose a Stock Motor Vehicle Outfitted with a Sports Theme Kit. The kit retrofits team-related goods to a stock car. The kit provides replacement hood ornaments and magnetically adhered decorations. The decorations do not enhance existing automobile insignias. No transparent resin is added to the magnets' surface to provide coloring or prismatic effects.

Nesbitt (U.S. Pat. No. 5,549,938) discloses Removable Camouflage. The camouflage comprises multiple magnetic spots that attach to a vehicle. The spots may have the pattern incorporated integrally or added by a veneer. The camouflage does not work with automobile insignias. The veneer's depth is not specified and no transparent prismatic layer is placed over the insignias.

Wu (U.S. Pat. No. 5,452,508) discloses a Method for Manufacturing Surface Three-Dimensional Figures on Magnetic Materials. The method involves adding a foam layer to a magnetic layer and forming the surface. The invention does not involve automobile insignias or a transparent prismatic resin.

Fielder et al. (U.S. Pat. No. 4,801,479) disclose a method of making Decorative Articles and Process for Making. The method involves flowing a transparent cap over an extended surface without the cap having an “orange peel” type surface. The transparent caps are to be used on car A-pillars. The method does not involve shaping the piece to complement an automobile insignia.

Sano et al. (U.S. Pat. No. 4,663,874) disclose a Magnetically Attachable Sign. The magnetic sign includes troughs in its rear surface to prevent air from forming air bubbles. The method does not involve shaping the piece to complement an automobile insignia.

Bree (U.S. Pat. No. 4,599,253) discloses a method for making decorative emblems and the like and shapes prepared by that method. Bree discloses a method of forming a sheet having a polyurethane layer over a substrate and then punching a shape from the sheet. The method prevents the punched pieces from having bowed or curved edges.

Stern (U.S. Pat. No. 4,310,978) discloses an advertising and promotional display material. Stern involves methods for thermally adhering magnetic elastomers to thermoplastics. Stern does not involve automobile insignia or their enhancement.

Thompson (U.S. Pat. No. 4,231,174) discloses a Protective Holder for Sheet Material. The invention provides a holder for protecting and attaching a sheet of paper on a steering wheel. Thompson does not involve automobile insignia or their enhancement.

Chamberlain (U.S. Pat. No. 2,293,887) discloses a Decorative Sheet Material and Method of Using the Same. This patent involves cutting pieces of colored transparent plastic cellophane and the attachment of several different pieces to form a colored picture. Chamberlain does not involve automobile insignia or their enhancement.

### SUMMARY OF THE INVENTION

It is accordingly an object of the invention to provide color inserts for automobile insignias that overcome the above-mentioned disadvantages of the heretofore-known devices and methods of this general type.

With the foregoing and other objects in view there is provided, in accordance with the invention, a filler for decorating an automobile insignia defining at least one space, including an insert filling the space.

The invention decorates automotive insignia (e.g. the H surrounded by a box for HONDA®, or the three lines in a circle for MERCEDES®). These insignia define a space between the symbol and the outer perimeter through which the underlying car panel can be seen.

With the foregoing and other objects in view there is provided, in accordance with the invention, the color insert of the invention fills the spaces in the insignia and decorates them.

In accordance with another feature of the invention, the color inserts contain the following overlapping layers listed in order from base to exterior:

a flexible magnet backing cut to fill the spaces in the emblem;

adhesive, such as double-sided tape, added to the exterior of the flexible magnetic backing;

a colored layer made with a transparent resin such as a polyester sold under the trademark MYLAR®, vinyl, or KODAK® film adhered to the adhesive;

a transparent surface layer covering the colored layer; the clear surface layer having a thickness equaling the automobile insignia. The clear surface layer is preferably made from a resin such as a vinyl resin, polyester resin, particularly of the type sold under the trademark MYLAR®, KODAK®, or a resin copolymer.

In accordance with another feature of the invention, the inserts can be exchanged with inserts having different colored layers.

In accordance with another feature of the invention, the transparent layer acts as a lens and can magnify an effect on the colored layer.

Other features that are considered as characteristic for the invention are set forth in the appended specification.

Although the invention is illustrated and described herein as embodied in colored inserts, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a side view of an insert.

FIG. 2 is a side view of an insert having photosensitive tape.

FIG. 3 is a side view of an insert having photosensitive tape adhered to a magnetic.

FIG. 4 is a plan view of an insert and an automobile insignia.

### DESCRIPTION OF THE PREFERRED EMBODIMENTS

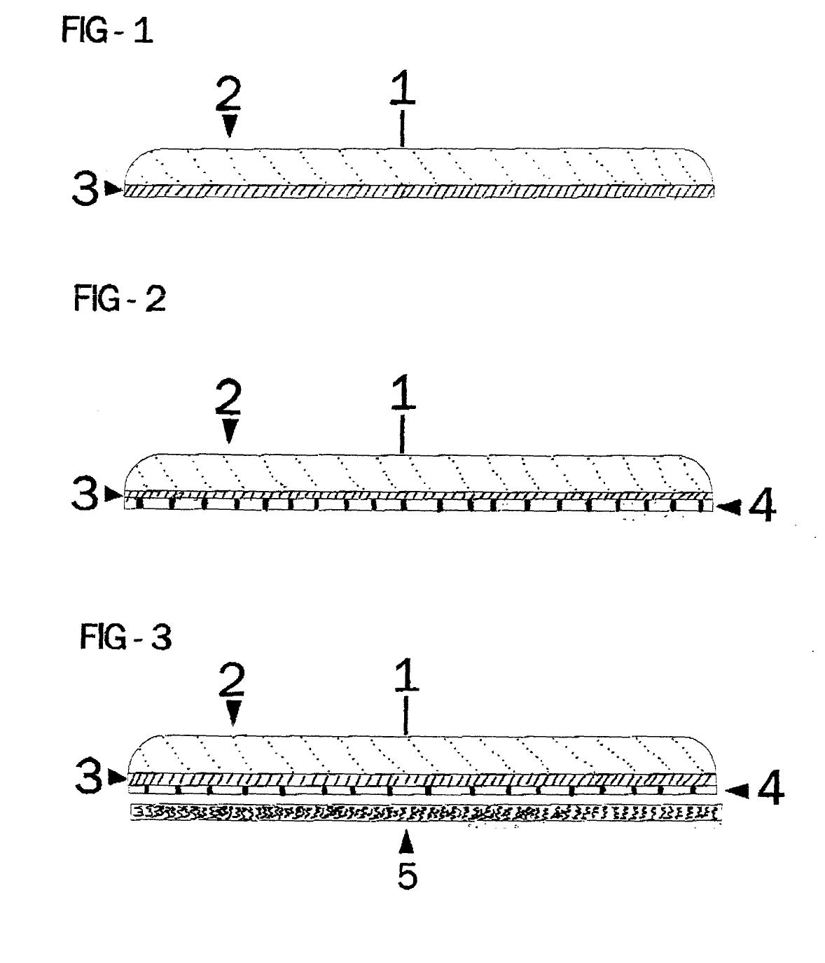

Referring now to the figures of the drawing in detail and first, particularly, to FIG. 1 thereof, there is seen a color insert 1. The color insert 1 has a colored layer 3. Typically the colored layer 3 is opaque. The colored layer 3 can also be reflective. The colored layer 3 can be colored to compliment the color of the automobile being decorated. The colored layer 3 can also be colored to form a design. The colored layer 3 has a outside facing away from the automobile and inside facing the automobile. Preferably, at least the outside is colored. The colored layer 3 is preferably a polyester film such as that sold under the trademarks MYLAR® and KODAK®. The colored layer 3 can also be made with Vinyl or other similar resins, foils, and papers.

A lens 2 overlays the outside of the colored layer 3. The lens 2 is a transparent resin. Preferably, the lens 2 is made from a material having a high refractive index; i.e. greater than the refractive index of air. Such a material produces a magnifying-glass effect over the colored layer 3. The lens 2 can have a thickness that makes it flush with an automobile insignia in which it is inserted.

FIG. 2 shows an embodiment similar to that in FIG. 1 with the addition of an adhesive layer 4. The adhesive layer 4 attaches to the inside of the colored layer 3. The adhesive layer 4 attaches the color insert 1 to the automobile. Preferably, the adhesive layer 4 is double-sided tape. Other adhesives such as glue are also possible. The adhesive layer 4 can be a type that allows the colored insert 1 to attach releasably to the automobile.

FIG. 3 depicts a further embodiment similar to FIG. 2 in which a magnet 5 is added to the inside of the adhesive layer 4. The magnet 5 allows the color insert to attach releasably to the automobile. Preferably, the magnet is rubberized to prevent scratches to the automobile's finish.

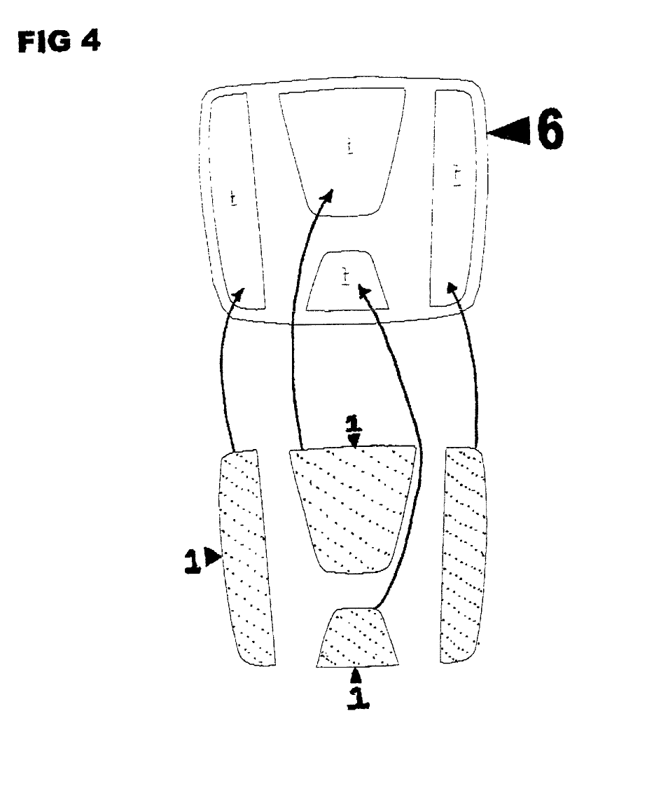

FIG. 4 shows an automobile insignia 6. The insignia 6 is a chrome insignia attached to the body of the automobile. The insignia 6 defines spaces 7 through which the underlying automobile is exposed. The colored inserts 1 are cut to match the spaces 7 and therefore complement the insignia 6. The colored inserts are then inserted into the spaces 7. The colored inserts 1 can be held on the automobile by magnet 5 or adhesive layer 4.

The different pieces of colored inserts 1 can have different colors to form different designs.

The colored inserts 1 are removable to allow easy customization and interchanging of pieces.

I claim:

1. A filler for decorating an automobile insignia defining at least one space, comprising an insert filling the space.

2. The filler according to claim 1, wherein said insert includes a colored layer.

3. The filler according to claim 2, wherein said colored layer is a polyester film.

4. The filler according to claim 3, wherein said colored layer is a vinyl.

5. The filler according to claim 2, wherein said colored layer has an outside, and a lens overlays and connects to said outside.

6. The filler according to claim 5, wherein said lens has a relatively high refractive index.

7. The filler according to claim 2, wherein said colored layer has an inside, and a magnet for attracting an automobile underlies and connects to said inside.

8. The filler according to claim 7, wherein said magnet is rubberized.

9. The filler according to claim 7, including an adhesive underlying said magnet for attaching to an automobile.

10. The filler according to claim 9, wherein said adhesive is double-sided tape.

11. The filler according to claim 2, wherein said colored layer has an inside, and an adhesive for attaching to an automobile underlies and connects to said inside.

12. The filler according to claim 11, wherein said adhesive is double-sided tape.
